(19) United States
(12) Patent Application Publication
(10) Pub. No.: US 2019/0248999 A1
(43) Pub. Date: Aug. 15, 2019

(54) A POLYMERIC COMPOSITION, ITS METHOD OF PREPARATION, ITS USE AND OBJECT COMPRISING IT

(71) Applicant: Arkeme France, Colombes (FR)

(72) Inventors: Benoit Andre, Evreux (FR); Cedric ROY, Corneville Sur Risle (FR); Sylvain QUERUEL, Beaumont Le Roger (FR); Jean-Michel TREMILLON, Croissy-Sur-Seine (FR)

(73) Assignee: Arkeme France, Colombes (FR)

(21) Appl. No.: 16/333,264

(22) PCT Filed: Sep. 20, 2017
(86) PCT No.: PCT/EP2017/073819

§ 371 Date: Mar. 14, 2019

(30) Foreign Application Priority Data
Sep. 20, 2016 (FR) 16 58819

(51) Int. Cl. C08L 33/12; C08J 5/18

(52) U.S. Cl. CPC C08L 33/12; C08J 5/18; C08J 2425/14; C08J 2333/12; C08L 2203/16

(57) ABSTRACT

The present invention relates to a polymeric composition comprising a (meth) acrylic polymer and a copolymer comprising at least 41% wt of a vinyl aromatic monomer. In particular the present invention relates to a polymeric (meth) acrylic composition comprising a (meth) acrylic polymer. The present invention concerns also the use of such a polymeric (meth) acrylic composition comprising a meth acrylic polymer and a copolymer comprising at least 41% wt of a vinyl aromatic monomer, (meth) acrylic acid ester monomer and dicarboxylic acid anhydride monomer for increasing the chemical resistance. The present invention concerns also an object comprising or made of such a meth) acrylic composition comprising a (meth) acrylic polymer and a copolymer comprising at least 41% wt of a vinyl aromatic monomer, (meth) acrylic acid ester monomer and dicarboxylic acid anhydride monomer with increasing the chemical resistance.

### FIELD OF THE INVENTION

The present invention relates to a polymeric composition comprising a (meth)acrylic polymer and a copolymer comprising at least 41% wt of a vinyl aromatic monomer.

In particular the present invention relates to a polymeric (meth) acrylic composition comprising a (meth)acrylic polymer and a copolymer comprising at least 41% wt of a vinyl aromatic monomer.

The present invention concerns also the use of such a polymeric (meth) acrylic composition comprising a (meth)acrylic polymer and a copolymer comprising at least 41% wt of a vinyl aromatic monomer, (meth)acrylic acid ester monomer and dicarboxylic acid anhydride monomer for increasing the chemical resistance.

The present invention concerns also an object comprising or made of such a (meth)acrylic composition comprising a (meth)acrylic polymer and a copolymer comprising at least 41% wt of a vinyl aromatic monomer, (meth)acrylic acid ester monomer and dicarboxylic acid anhydride monomer with increasing the chemical resistance.

### TECHNICAL PROBLEM

Thermoplastic polymers and especially (meth) acrylic polymers are widely used, including in building and construction, lightning, consumer goods, transportation, automotive, household appliances, bathroom applications and cosmetic packaging and displays. This is mainly due to its characteristics as a highly transparent polymer material with excellent resistance to ultraviolet radiation and weathering. So (meth) acrylic polymers are used for example in transportation, building and construction.

These applications have various requests on the (meth) acrylic polymers or the compositions based on (meth) acrylic polymers as hardness but also heat and chemical resistance. These compositions based on (meth) acrylic polymers can be prepared by polymerizing (meth)acrylic to a very high molecular weight or even crosslink the polymer. However these polymers cannot be transformed easily anymore, especially not used for extrusion or injection molding for having a great liberty of thermoplastic transformation. For that the (meth) acrylic polymers require a certain fluidity.

Additionally it is also of great interest to have a polymeric composition with a good compromise between chemical resistance, adapted flowability for transformation and thermal resistance.

The objective of the present invention is to provide a polymeric composition with satisfying chemical resistance, adapted flowability for transformation and satisfying thermal resistance.

A further objective of the present invention is to provide a process for producing a polymeric composition with satisfying chemical resistance, adapted flowability for transformation and satisfying thermal resistance.

Another objective of the present invention is to provide a polymeric composition which combines the characteristics of satisfying chemical resistance, adapted flowability for transformation and satisfying thermal resistance, at the same time.

Another objective of the present invention is to provide a polymeric composition that can be used to increase the chemical resistance while having adapted flowability for transformation and satisfying thermal resistance.

Another objective of the present invention is to provide a polymeric composition that can be transformed to an object having a satisfying chemical resistance and satisfying thermal resistance.

Another objective of the present invention is to provide an object comprising a (polymeric composition having a satisfying chemical resistance and satisfying thermal resistance.

### BACKGROUND OF THE INVENTION

### Prior Art

The document EP2881407 discloses a copolymer for improving the heat resistance of a methacrylic resin. Said copolymer comprises 45 to 85 mass % of an aromatic vinyl monomer unit; 5 to 45 mass % of a (meth)acrylic acid ester monomer unit; and 10 to 20 mass % of an unsaturated dicarboxylic acid anhydride monomer. The copolymer is used at 5 to 50 mass % in a methacrylic resin. The methacrylic resin comprises 70 to 100mass % of meth(acrylic) acid ester units. The document does not mention anything about chemical resistance.

The document EP1742997 discloses a moulding composition for mouldings with high weather resistance. The moulding composition comprises two copolymers: copolymer (I) and copolymer (II). The copolymer (I) is produced by polymerization of 90-100 percent by weight methylmethacrylate, styrene and malic acid anhydride, and optionally 0-10 percent by weight additional monomers which can be copolymerised with methylmethacrylate. A suitable copolymer (I) comprises from 10 to 20% by weight of styrene. The copolymer (II) is produced by polymerization of 80-100 percent by weight methylmethacrylate and optionally 0-20 percent by weight additional monomers which can be copolymerised with methylmethacrylate.

The document EP0113105 discloses a methacrylic resin comprising a copolymer (I) obtained by copolymerizing methyl methacrylate, an aromatic vinyl compound and maleic anhydride and a copolymer [II] obtained by copolymerizing 80 to 100 percent by weight of methyl methacrylate and 0 to 20 percent by weight of other copolymerizable ethylenic monomer.

The document JP2003292714 discloses a solvent resistant resin composition. The composition comprises a 40-80 parts by weight of a copolymer (A) and 60-20 parts by weight of a copolymer (B), wherein the copolymer (A) is composed of 85-95 weight percent of MMA (methyl methacrylate) units and 5-15 weight percent of MA (methyl acrylate) units and the copolymer (B) which is a terpolymer is composed of 70-80 weight percent of MMA units, 12-18 weight percent of ST (styrene) units and 8-12 weight percent of MAH (maleic anhydride) units.

The document JP2011026563 discloses an acrylic resin composition. The resin composition comprises a copolymer comprising a repeating unit from an aromatic vinyl monomer. This aromatic vinyl monomer is present in a content of 5 to 40 wt % in the copolymer. Preferably the aromatic vinyl monomer is styrene or alpha-methyl styrene.

The document WO98/28365 discloses a polymer composition consisting of a copolymer of styrene units and maleic anhydride units and a copolymer containing methyl methacrylate units.

The prior art does not disclose a composition suitable for increasing the chemical resistance while having adapted flowability for transformation and a satisfying thermal resistance at the same time and the use of copolymers or compositions increasing the chemical resistance while having adapted flowability for transformation and a satisfying thermal resistance at the same time.

### BRIEF DESCRIPTION OF THE INVENTION

Surprisingly it has been discovered that a polymeric composition comprising:
a) a (meth)acrylic polymer AP1 and
b) a copolymer CP1 comprising at least 41% wt of a vinyl aromatic monomer,
   possesses a better chemical resistance than the (meth)acrylic polymer AP1 alone.

It has also been found that a composition obtained by a process of preparation of a polymeric composition suitable for increasing the chemical resistance, said composition comprising:
a) a (meth)acrylic polymer AP1 and
b) a copolymer CP1 comprising at least 41% wt of a vinyl aromatic monomer,
   and said process comprises the step of blending the components a) and b); yields to a composition having satisfying compromise between chemical resistance, flow properties for transformation and thermal resistance.

It has also been found that an object comprising a composition comprising:
a) a (meth)acrylic polymer AP1 and
b) a copolymer CP1 comprising at least 41% wt of a vinyl aromatic monomer,
   possesses a better chemical resistance than an object comprising the (meth)acrylic polymer AP1 alone.

Additionally it has been found that a copolymer CP1 comprising at least 41% wt of a vinyl aromatic monomer can be used in a composition comprising:
a) a (meth)acrylic polymer AP1 and
b) said copolymer CP1 comprising at least 41% wt of a vinyl aromatic monomer,
   for increasing the chemical resistance of the (meth)acrylic polymer AP1.

Additionally it has been found that a composition comprising:
a) a (meth)acrylic polymer AP1 and
b) a copolymer CP1 comprising at least 41% wt of a vinyl aromatic monomer,
   can be used for making an object that possesses a better chemical resistance than an object that uses the (meth)acrylic polymer AP1 alone.

### DETAILED DESCRIPTION OF THE INVENTION

According to a first aspect, the present invention relates to polymeric composition comprising:
a) a (meth)acrylic polymer AP1 and
b) a copolymer CP1 comprising at least 41% wt of a vinyl aromatic monomer,
   characterized that the copolymer CP1 represents at least 5 wt % of polymeric composition.

According to a second aspect, the present invention relates to a process of preparation of a polymeric composition (suitable for making objects said composition) comprising:
a) a (meth)acrylic polymer AP1 and
b) a copolymer CP1 comprising at least 41% wt of a vinyl aromatic monomer,
   characterized that said process comprises the step of blending the components a)and b).

According to another aspect the present invention relates to the use of a polymeric composition comprising:
a) a (meth)acrylic polymer AP1 and
b) a copolymer CP1 comprising at least 41% wt of a vinyl aromatic monomer,
   characterized that that the copolymer CP1 represents at least 5 wt % of polymeric composition.

Still another aspect of the present invention relates to an object comprising a polymeric composition or made of a polymeric composition, said polymer composition is comprising:
a) a (meth)acrylic polymer AP1
b) a copolymer CP1 comprising at least 41% wt of a vinyl aromatic monomer,
   characterized that the that the copolymer CP1 represents at least 5 wt % of polymeric composition.

By the term “alkyl(meth)acrylate” as used is denoted to both alkyl acrylate and alkyl methacrylate.

By the term “units” as used are denoted the respective monomers in a polymeric chain after polymerization

By the term “copolymer” as used is denoted that the polymers consists of at least two different monomers or units.

By the term “parts” as used herein is denoted “parts by weight”.

By the term “thermoplastic polymer” as used is denoted a polymer that turns to a liquid or becomes more liquid or less viscous when heated and that can take on new shapes by the application of heat and pressure.

By the term “PMMA” as used in the present invention are denoted homo- or copolymers of methyl methacrylate (MMA), for the copolymer of MMA the weight ratio of MMA inside the PMMA is at least 50 wt %.

With regard to the composition according to the invention it comprises a (meth)acrylic polymer AP1 and copolymer CP1 comprising at least 41% wt of a vinyl aromatic monomer.

The polymeric composition comprises at least 5 wt % of the copolymer CP1 comprising at least 41% wt of a vinyl aromatic monomer, preferably at least 6 wt %, more preferably at least 8 wt %, advantageously at least 10 wt %, most advantageously at least 12 wt %. Preferably the copolymer CP1 represents between 5 wt % and 50 wt % of the polymeric composition. More preferably the copolymer CP1 represents between 6 wt % and 45 wt %, still more preferably between 7 wt % and 40 wt %, advantageously between 8 wt % and 35 wt %, more advantageously between 10 wt % and 35 wt % and most advantageously between 12 wt % and 35 wt % of the polymeric composition.

With regard to the (meth)acrylic polymer AP1 it is a polymeric polymer chain comprising at least 50 wt % of monomers coming acrylic and/or methacrylic monomers. The (meth)acrylic polymer could also be a mixture of two or more (meth)acrylic polymer AP1 to APx.

The acrylic and/or methacrylic monomers are chosen from acrylic acid, methacrylic acid, esters of acrylic acid of esters of methacrylic acid, alkyl acrylic monomers, alkyl methacrylic monomers and mixtures thereof.

Preferably the monomer is chosen from acrylic acid, methacrylic acid, alkyl acrylic monomers, alkyl methacrylic monomers and mixtures thereof, the alkyl group having from 1 to 22 carbons, either linear, branched or cyclic; preferably the alkyl group having from 1 to 12 carbons, either linear, branched or cyclic.

Advantageously the meth)acrylic monomer is chosen from methyl methacrylate, ethyl methacrylate, methyl acrylate, ethyl acrylate, methacrylic acid, acrylic acid, n-butyl acrylate, iso-butyl acrylate, n- butyl methacrylate, iso-butyl methacrylate, cyclohexyl acrylate, cyclohexyl methacrylate, isobornyl acrylate, isobornyl methacrylate and mixtures thereof.

Other comonomers can be copolymerized with the acrylic and/or methacrylic monomers as long as the (meth)acrylic polymer AP1 is comprising at least 50 wt % of monomers coming acrylic and/or methacrylic monomers in its polymeric chain. The other comonomers can be chosen from styrenic monomers as styrene or styrene deriviatives, acrylonitrile, vinylesters as vinylacetate. The amount of these comonomers is from 0 wt % to 50 wt %, preferably from 0 wt % to 40 wt %, more preferably from 0 wt % to 30 wt %, advantageously from 0 wt % to 20 wt %.

In a first preferred embodiment the (meth)acrylic polymer AP1 is a homo- or copolymer of methyl methacrylate (MMA) that comprises at least 50%, preferably at least 60%, advantageously at least 70% and more advantageously at least 80% by weight of methyl methacrylate.

The copolymer of methyl methacrylate (MMA) comprises between 50% and 99.9% by weight of methyl methacrylate and between 0.1 and 50% by weight of at least one monomer having at least one ethylenic unsaturation that can copolymerize with methyl methacrylate.

These monomers are well known and mention may be made, in particular of acrylic and methacrylic acids and alkyl-(meth)acrylates in which the alkyl group has from 1 to 12 carbon atoms. As examples, mention may be made of methyl acrylate and ethyl, butyl or 2-ethylhexyl (meth)acrylate. Preferably the comonomer is an alkyl acrylate in which the alkyl group having from 1 to 4 carbon atoms.

According to the first more preferred embodiment the copolymer of methyl methacrylate (MMA) comprises from 80% to 99.8% advantageously from 90% to 99.7% and more advantageously from 90% to 99.5% by weight of methyl methacrylate and from 0.2% to 20% advantageously from 0.3% to 10% and more advantageously from 0.5% to 10% by weight of at least one monomer having at least one ethylenic unsaturation that can copolymerize with methyl methacrylate. Preferably the comonomer is chosen from methyl acrylate or ethyl acrylate or mixtures thereof.

The (meth)acrylic polymer AP1 has a melt flow index (MFI) according to ISO 1133 (230° C./3.8 kg) between 0.1 g and 20 g/10 min.

Preferably melt flow index is between 0.2 g and 18 g/10 min, more preferably between 0.3 g and 16 g/10 min, advantageously between 0.4 g and 13 g/10 min.

The (meth)acrylic polymer AP1 has a refractive index between 1.46- and 1.52, preferably between 1.47 and 1.52 and more preferably between 1.48 and 1.52.

The (meth)acrylic polymer AP1 has a light transmittance according to ASTM D-1003 (sheet measured at 3 mm thickness) of at least 85%, preferably 86%, more preferably 87%.

The (meth)acrylic polymer AP1 has a Vicat softening temperature of at least 90° C. The Vicat softening temperature is measured according to ISO 306:2013 (B50 method).

The composition according to the invention can comprise beside the (meth)acrylic polymer AP1 also an (meth)acrylic polymer AP2. The (meth)acrylic polymer AP1 and (meth)acrylic polymer AP2 form a mixture or a blend. This mixture or blend consists of at least one homopolymer and at least one copolymer of MMA, or a mixture of at least two homopolymers or two copolymers of MMA with a different average molecular weight or a mixture of at least two copolymers of MMA with a different monomer composition.

With regard to the copolymer CP1 comprising at least 41% wt of a vinyl aromatic monomer polymeric, the vinyl aromatic monomer is preferably derived from a styrene based monomer.

Preferably the copolymer CP1 comprises at most 84 wt % of the vinyl aromatic monomer. Preferably the copolymer CP1 comprises between 41 wt % and 84 wt % of the vinyl aromatic monomer.

Preferably the copolymer CP1 comprises at least 6 wt % of a (meth)acrylic acid ester monomer. Preferably the copolymer CP1 comprises at most 49 wt % of a (meth)acrylic acid ester monomer. More preferably the copolymer CP1 comprises between 6 wt % and 49 wt % of a (meth)acrylic acid ester monomer.

Preferably the copolymer CP1 comprises at least 10 wt % of an unsaturated dicarboxylic acid anhydride monomer. Preferably the copolymer CP1 comprises at most 20 wt % of an unsaturated dicarboxylic acid anhydride monomer. Still more preferably the copolymer CP1 comprises between 10 wt % and 20 wt % of an unsaturated dicarboxylic acid anhydride monomer.

Most preferably the copolymer CP1 comprises between 41 wt % and 84 wt % of the vinyl aromatic monomer, between 6 wt % and 49 wt % of a (meth)acrylic acid ester monomer and between 10 wt % and 20 wt % of an unsaturated dicarboxylic acid anhydride monomer.

Advantageously the copolymer CP1 comprises between 46 wt % and 81 t % of the vinyl aromatic monomer units.

More advantageously the copolymer CP1 comprises between 8 wt % and 35 wt % of a (meth)acrylic acid ester monomer units.

Still more advantageously the copolymer CP1 comprises between 11 wt % and 19 wt % of an unsaturated dicarboxylic acid anhydride monomer units.

Most advantageously the copolymer CP1 comprises between 46 wt % and 81 wt % of the vinyl aromatic monomer units, between 8 wt % and 35 wt % of a (meth)acrylic acid ester monomer units and between 11 wt % and 19 wt % of an unsaturated dicarboxylic acid anhydride monomer units.

The styrene based monomer of the copolymer CP1 is chosen from styrene, o-methyl styrene, m-methyl styrene, p-methyl styrene, 2,4-dimethyl styrene, ethyl styrene, p-tert-butyl styrene, a-methyl styrene, and a-methyl-p-methyl styrene and mixtures thereof. Among these, styrene is preferable.

The (meth)acrylic acid ester monomer of the copolymer CP1 is chosen from various methacrylic acid ester monomers such as methyl methacrylate, ethyl methacrylate, n-butyl methacrylate, 2-ethylhexyl methacrylate, dicyclopentanyl methacrylate, and isobornyl methacrylate; and various acrylic acid ester monomers such as methyl acrylate, ethyl acrylate, n-butyl acrylate, 2-methylhexyl acrylate, 2-ethylhexyl acrylate, and decyl acrylate and mixtures thereof. Among these, methyl methacrylate unit is preferable.

As the unsaturated dicarboxylic acid anhydride monomer of the copolymer CP1 is chosen from various acid anhydride monomers such as maleic anhydride, itaconic anhydride, citraconic anhydride, and aconitic anhydride and mixtures thereof. Among these, maleic anhydride unit is preferable.

The copolymer CP1 has a total light transmittance of 88 percent or more, the total light transmittance being measured in accordance with ASTM D1003 for a sample with 3 mm thickness.

The copolymer CP1 can also contain optionally a copolymerizable vinyl monomer unit other than the aromatic vinyl monomer, the (meth)acrylic acid ester monomer, and the unsaturated dicarboxylic acid anhydride monomer, by an amount which does not have an adverse effect to the effect of the present invention. Here, the preferable amount is 5 wt % or less. As an example of the copolymerizable vinyl monomer unit, units derived from vinyl cyanide monomers such as acrylonitrile and methacrylonitrile; vinyl carboxylic acid monomers such as acrylic acid and methacrylic acid; N-alkyl maleimide monomers such as N-methyl maleimide, N-ethyl maleimide, N-butyl maleimide, and N-cyclohexyl maleimide; N-aryl maleimide monomers such as N-phenyl maleimide, N-methylphenyl maleimide, and N-chlorophenyl maleimide can be mentioned. The copolymerizable vinyl monomer unit can comprise two or more types of these units

A method of preparation of a copolymer CP1 is described in EP2881407.

With regard to the polymeric composition of the invention or the (meth)acrylic polymer AP1, in one embodiment of the invention it can be additionally impact modified. That means that the polymeric composition comprises an impact modifier. There are different way to add the impact modifier to the polymeric composition.

In one embodiment the polymeric composition comprises an impact modified (meth)acrylic polymer AP1. That means that an impact modified (meth)acrylic polymer AP1 is added to the composition. The (meth)acrylic polymer AP1 comprises at least an impact modifier IM1.

In another embodiment an impact modifier IM2 is added to the polymeric composition.

Preferred impact modifiers are core-shell multi-layer polymers and block copolymers having at least one hard and at least one soft block. The core-shell (multi-layer) impact modifiers could have a soft (rubber or elastomer) core and a hard shell, a hard core covered with a soft elastomer-layer, and a hard shell, of other core-shell morphology known in the art. The rubber layers are composed of low glass transition (Tg) polymers, including, but not limited to polymers made of butyl acrylate (BA), ethylhexyl acrylate (EHA), butadiene (BD), butylacrylate/styrene, and many other combinations. The preferred glass transition temperature (Tg) of the elastomeric core or layer should be below 20° C., preferably below 0° C. The glass transition temperature Tg of the polymer is measured with dynamic differential calorimetry (differential scanning calorimetry, DSC) according to ISO 11357-2/2013. The elastomeric or rubber layer is normally crosslinked by a multifunctional monomer for improved energy absorption. Crosslinking monomers suitable for use as the crosslinker in the core/shell impact modifier are well known to those skilled in the art, and are generally monomers copolymerizable with the monounsaturated monomer present, and having ethylenically multifunctional groups that have approximately equal reactivity. Examples include, but are not limited to, divinylbenzene, glycol of di- and trimethacrylates and acrylates, triol triacrylates, methacrylates, and allyl metliacrylates, etc. A grafting monomer is also used to enhance the interlayer grafting of impact modifiers and the matrix/modifier particle grafting. The grafting monomers can be any polyfunctional crosslinking monomers. For soft core multi-layered impact modifies, the core ranges from 30 wt % to 85 wt % of the impact modifier, and outer shells range from 15 wt % to 70 wt %. The crosslinker in the elastomeric layer ranges from 0 wt % to 5 wt % percent. The synthesis of core-shell impact modifiers is well known in the art, and there are many references, for example U.S. Pat. Nos. 3,793,402, 3,808,180, 3,971,835, and 3,671,610.

The impact modifier IM1 or IM2 for the (meth)acrylic polymer AP1 or the polymeric composition is preferably a core-shell impact modifier particle well known from prior art. The weight average diameter of the particles is in general less than 1 μm and advantageously between 50 and 400 nm.

Preferably the impact modifier is a multi-stage, sequentially-produced polymer having a core/shell particle structure of at least three layers made of a hard core layer, one or more intermediate elastomeric layers, and a hard shell layer. The non-elastomeric polymer or “hard core” polymer formed in the first stage of polymerization has a glass transition temperature of greater than 25° C., and it is linked to an elastomeric polymer prepared in a subsequent stage from monomeric constituents such that the glass transition temperature thereof is 20° C. or less, preferably less than 10° C., and such elastomeric polymer is in turn linked to a polymer prepared in a subsequent stage from monomers such that the glass transition temperature of the polymer is preferably greater than 25° C., and most preferably at least 60° C. The glass transition temperature Tg of the respective polymers is measured with dynamic differential calorimetry (differential scanning calorimetry, DSC) according to ISO 11357-2/2013

Preferably the polymeric composition of the invention, if impact modified, comprises the (meth)acrylic polymer AP1 that comprises an acrylic core-shell impact modifier. Suitable acrylic impact modifiers and/or process for making them are disclosed in U.S. Pat. Nos. 3,793,402 and 3,808,180. The ratio between the impact modifier and the (meth)acrylic polymer AP1 is that the (meth)acrylic polymer AP1 presents between 40 wt % and 90 wt % of the composition comprising the impact modifier and the (meth)acrylic polymer AP1.

The polymeric composition can optionally be formulated with stabilizers, plasticizers, lubricants, antioxidants, ultraviolet absorbers, light stabilizers, colorants, and the like.

With regard to the process for the preparation a polymeric composition according to the invention, it comprises the step of blending the components a) and b).

The blending can be made by kneading and mixing the (meth)acrylic polymer AP1 and the copolymer CP1. Here, known techniques for melt kneading can be used. As a preferably used melt kneading device, screw extruders such as a single screw extruder, a twin screw extruder having engaging flights and screws rotating in the same direction, a twin screw extruder having engaging flights and screws rotating in different directions, and a twin screw extruder having non-engaging or partially-engaging flights; a Banbury mixer; a ko-kneader; and a mixing mill can be mentioned.

Preferably the process is made by compounding on an extruder and more preferably on one of the before mentioned twin screw extruders.

Said process is also capable for the preparation of a polymeric composition suitable for making objects with said composition.

Preferably the process for the preparation of a polymeric composition comprises at least one of the following blending steps
mixing the a) (meth)acrylic polymer AP1 with b) a copolymer CP1 comprising at least 41% wt of a vinyl aromatic monomer;
mixing a composition comprising a) (meth)acrylic polymer AP1 and an impact modifier IM1 with a b) a copolymer CP1 comprising at least 41% wt of a vinyl aromatic monomer;
mixing a composition comprising a) (meth)acrylic polymer AP1 with a b) a copolymer CP1 comprising at least 41% wt of a vinyl aromatic monomer and with an impact modifier IM1 or IM2;
mixing a composition comprising a) (meth)acrylic polymer AP1 and an impact modifier IM1 with a b) a copolymer CP1 comprising at least 41% wt of a vinyl aromatic monomer and with an impact modifier IM2, whereby IM1 and IM2 could be same or different.

The a (meth)acrylic polymer AP1 and a copolymer CP1 comprising at least 41% wt of a vinyl aromatic monomer are the same as described before.

Optionally the process can also comprise the step of mixing additionally a component comprising a masterbatch with additives. The component comprising the masterbatch with additives, can be an additional component, but it could also be the component a) (meth)acrylic polymer AP1 or the component b) the copolymer CP1 comprising at least 41% wt of a vinyl aromatic monomer which comprises already that additive and serves as masterbatch.

According to a further aspect the present invention concerns the use of the composition for increasing the chemical resistance.

According to a still further aspect the present invention concerns the use of the composition for making an object or a moulded object, said object has an increased chemical resistance.

According to a still additional aspect the present invention concerns a method to increase the chemical resistance of a composition comprising a (meth)acrylic polymer AP1, said composition can be used for making an object or a moulded object. The process comprises the step of blending the component a) the (meth)acrylic polymer AP1 and b) a copolymer CP1 comprising at least 41% wt of a vinyl aromatic monomer. The (meth)acrylic polymer

AP1 and the copolymer CP1 comprising at least 41% wt of a vinyl aromatic monomer are the same as defined before.

The composition according to the invention can be used for making an object or a moulded object or article or be used to be part of an article or object.

The composition obtained by the process according to the invention can be used to be transformed directly into an article or object or can be part of an article or object.

According to a further aspect the present invention concerns a process for making an object by transforming and/or processing the polymeric composition according to the invention.

The transformation can be made by injection moulding, extrusion, coextrusion or extrusion/blow molding. Preferably the transformation is made by injection moulding, coextrusion or extrusion.

According to a still further aspect the present invention concerns an object or a moulded object made of or comprising the polymeric composition according to the present invention.

The object or moulded object of the invention can be in form of a sheet, block, film, multilayer film, foil, tube or profiled element.

Additionally according to another aspect of the present invention the composition according to the invention can used in building and construction, lightning, consumer goods, household applications, transportation, automotive, household appliances, sanitary applications or bathroom applications and cosmetic packaging and cosmetic stands or displays, and packaging, .

The composition according to the invention has a variety of specific applications such as, for example:
shower trays
bathtubs
alimentary films
panels for washing machines
panels for dishwashers
panels for transportation machines.

### Methods

The optical properties of the polymers are measured according to following method: light transmittance and haze are measured according to the standard ASTM D1003, sheets of 3 mm thickness.

The melt flow ratio (MFR) is measured according to standard ISO 1133, with a temperature of 230° C. and a load of 3.8 kg.

The vicat value or temperature are measured according to standard IS 306 (method B50).

The chemical resistance is evaluated by the time to crack.

Specimens: For the following tests, specimens are cutted lengthwise with a saw, in the middle of injected sample plates (100*100 mm) with 3 mm thickness, and with mirror finished surface. If necessary, and to avoid edge effects on the result test, the sides are trimmed. The size of the final test specimens are 25 mm width, and 100 mm long.

Conditioning: The test specimens are dried at 80° C. for 16 h and stored at 23° C. and 50% relative humidity minimum 24 h until the test.

Test: Test is made at a temperature of 20° C. The specimen is maintained above a rounded shaper, with constant radius for applying a bending stress to the outer surface. After a relaxation time about 10 min, the surface of the specimen is wetted with a cloth soaked in the test liquid (Isopropanol 99%). For the following results, the strain of the outer surface of the specimen is 0.75%. The “time to crack” is determined by the time necessary to obtain a complete break in two parts of the test specimen.

Pieces of cloth: This piece is of dimension: 15 mm×10 mm and made of cotton. The piece of fabric is placed in the center of the specimen to avoid wetting the edges. Wetting rough edges can cause untimely cracking. The humidity of the piece of fabric is maintained using a pipette to prevent evaporation of the liquid test.

### EXAMPLES

The series of examples concern the preparation of polymeric compositions.

As (meth)acrylic polymer AP1 a copolymer of methyl methacrylate having a melt flow index of 2.8 g/10 min (at 230° C./3.8 kg) and a Vicat softening temperature of 108° C. is used. Commercial grade V825T® from Altuglas is used. This polymer is referenced as AP1a.

A copolymer CP1 the commercial grade Resify R200 from Denki is used.

As impact modifier a product as described in U.S. Pat No. 3,793,402 example 2 is prepared and is blended with the (meth)acrylic polymer AP1a at 50 wt %. The obtained composition is referenced as AP1b.

### EXAMPLES

Following compositions are prepared with the (meth)acrylic polymer AP1, the composition AP1b respectively and copolymer CP1 by by compounding on a extruder.

TABLE 1
polymeric compositions of respective (meth)acrylic
polymer AP1 and copolymer CP1

| | AP1a | AP1b | CP1 |
|---|---|---|---|
| | [wt %] | [wt %] | [wt %] |
| Comparative example 1 | 100 | 0 | 0 |
| Example 1 | 90 | 0 | 10 |
| Example 2 | 87 | 0 | 13 |
| Example 3 | 84 | 0 | 16 |
| Example 4 | 80 | 0 | 20 |
| Example 5 | 70 | 0 | 30 |
| Comparative example 2 | 0 | 100 | 0 |
| example 6 | | 80 | 20 |
| example 7 | | 70 | 30 |

The compositions of the respective examples and comparative examples are injection molded to sheets from which specimen are prepared as described above.

TABLE 2
evaluation of polymeric compositions of respective (meth)acrylic
polymer AP1 and copolymer CP1 and coextruded samples
comprising the compositions of the respective examples
and comparative examples of table 1

| | MFR | Vicat | Time to crack |
|---|---|---|---|
| | [g/10 min] | [° C.] | [min] |
| Comparative example 1 | 2.8 | 108 | 3.5 |
| Example 1 | 2.8 | 111 | 4.5 |
| Example 2 | 2.8 | 112 | 12 |
| Example 3 | 2.7 | 113 | 15 |
| Example 4 | 2.7 | 114 | 24 |
| Example 5 | 2.6 | 116 | 33 |
| Comparative example 2 | 0.8 | 100 | 8 |
| example 6 | 1.0 | 107 | No crack* |
| example 7 | 1.8 | 108 | No crack* |

*after one hour

The samples comprising the composition according to the invention show an increased chemical resistance evaluated by the time to crack.

The copolymer CP1 can be used to increase the chemical resistance of a (meth)acrylic polymer AP1.

The MFR of the composition comprising a (meth)acrylic polymer AP1 is not significantly influenced by the copolymer CP1.

The MFR of the composition comprising an impact modified (meth)acrylic polymer AP1 is slightly increased by the copolymer CP1, allowing better transformation.

1. A polymeric composition comprising:
a) a (meth)acrylic polymer AP1 and
b) a copolymer CP1 comprising at least 41% wt of vinyl aromatic monomer units,
wherein the copolymer CP1 represents at least 5 wt % of said polymeric composition.

2. The polymeric composition according to claim 1 wherein the copolymer CP1 represents between 5 wt % and 50 wt % of the polymeric composition.

3. The polymeric composition according to claim 1 wherein the copolymer CP1 represents between 12 wt % and 35 wt % of the polymeric composition.

4. The polymeric composition according to claim 1, wherein the copolymer CP1 comprises between 41 wt % and 84 wt % of vinyl aromatic monomer units.

5. The polymeric composition according to claim 4, wherein the copolymer CP1 comprises between 46 wt % and 81 wt % of vinyl aromatic monomer units.

6. The polymeric composition according to claim 1, wherein the copolymer CP1 comprises between 10 wt % and 20 wt % of unsaturated dicarboxylic acid anhydride monomer units.

7. The polymeric composition according to claim 6, wherein the copolymer CP1 comprises between 11 wt % and 19 wt % of at least one unsaturated dicarboxylic acid anhydride monomer units.

8. The polymeric composition according to claim 1, wherein the copolymer CP1 comprises between 6 wt % and 49 wt % of (meth)acrylic acid ester monomer units.

9. The polymeric composition according to claim 8, wherein the copolymer CP1 comprises between 8 wt % and 35 wt % of (meth)acrylic acid ester monomer units.

10. The polymeric composition according to claim 1, wherein the copolymer CP1 comprises between 41 wt % and 84 wt % of vinyl aromatic monomer units, between 6 wt % and 49 wt % of (meth)acrylic acid ester monomer units, and between 10 wt % and 20 wt % of at least one unsaturated dicarboxylic acid anhydride monomer units.

11. The polymeric composition according to claim 10, wherein the copolymer CP1 comprises between 46 wt % and 81 wt % of the vinyl aromatic monomer units, between 8 wt % and 35 wt % of a (meth)acrylic acid ester monomer unit, and between 11 wt % and 19 wt % of at least one unsaturated dicarboxylic acid anhydride monomer units.

12. The polymeric composition according to claim 1, wherein the (meth)acrylic polymer AP1 comprises at least 50 wt % of acrylic and/or methacrylic monomer units.

13. The polymeric composition according to claim 1, wherein the (meth)acrylic polymer AP1 is a homo- or copolymer of methyl methacrylate (MMA) that comprises at least 50% by weight of methyl methacrylate monomer units.

14. The polymeric composition according to claim 13, wherein the copolymer of methyl methacrylate (MMA) comprises from 80% to 99.8% by weight of methyl methacrylate monomer units and from 0.2% to 20% by weight of at least one monomer unit having at least one ethylenic unsaturation that can copolymerize with methyl methacrylate.

15. The polymeric composition according to claim 1, wherein the (meth)acrylic polymer AP1 has a melt flow index (MFI) according to ISO 1133 (230° C./3.8 kg) between 0.1 g and 20 g/10 min.

16. The polymeric composition according to claim 1, wherein the (meth)acrylic polymer AP1 has a melt flow index (MFI) according to ISO 1133 (230° C./3.8 g) between 0.4 g and 13 g/10 min.

17. The polymeric composition according to claim 1, wherein the composition is impact modified.

18. Process for the preparation of a polymeric composition according to claim 1 comprising
a) a (meth)acrylic polymer AP1 and
b) a copolymer CP1 comprising at least 41% wt of vinyl aromatic monomer units;
wherein said process comprises the step of blending the components a) and b).

19. The process according to claim 18, wherein the blending is is made by compounding on an extruder.

20. The process according to claim 18, wherein the process for the preparation of a polymeric composition comprises at least one of the following blending steps:
mixing the a) (meth)acrylic polymer AP1 with b) a copolymer CP1 comprising at least 41% wt of vinyl aromatic monomer units;
mixing a composition comprising a) (meth)acrylic polymer AP1 and an impact modifier IM1 with a b) a copolymer CP1 comprising at least 41% wt of vinyl aromatic monomer units;
mixing a composition comprising a) (meth)acrylic polymer AP1 . . . with b) a copolymer CP1 comprising at least 41% wt of vinyl aromatic monomer units and with an impact modifier IM1 or IM2;
mixing a composition comprising a) (meth)acrylic polymer AP1 and an impact modifier IM1 with a b) a copolymer CP1 comprising at least 41% wt of vinyl aromatic monomer units, and with an impact modifier IM2, whereby IM1 and IM2 could be same or different.

21. The process according to claim 18, wherein the process for the preparation of the polymeric composition comprises the following blending step:
mixing a composition comprising a) (meth)acrylic polymer AP1and an impact modifier IM1 with a b) a copolymer CP1 comprising at least 41% wt of vinyl aromatic monomer units.

22. The process according to claim 18, wherein the process for the preparation of the polymeric composition comprises the following blending step:
mixing a composition comprising a) (meth)acrylic polymer AP1 with b) a copolymer CP1 comprising at least 41% wt of a vinyl aromatic monomer monomer units and with an impact modifier IM1 or IM2.

23. The process according lo claim 18, wherein the process for the preparation of the polymeric composition comprises the following blending step:
mixing a composition comprising a) (meth)acrylic polymer AP1 and an impact modifier with b) a copolymer CP1 comprising at least 41% wt of vinyl aromatic monomer units and with an impact modifier IM1 or IM2, whereby IM1 and IM2 could be the same or different.

24. (canceled)

25. A process, for increasing the chemical resistance of an object comprising the step of blending said composition of claim 1 into said object.

26. (canceled)

27. An object comprising the polymeric composition according to claim 1.

28. The object according to claim 27, wherein the object is in form of a sheet, block, film, multilayer film, foil, tube or profiled element.

29. The object of claim 28, wherein said object is part of building and construction, lightning, consumer goods, household applications, transportation, automotive, household appliances, sanitary applications or bathroom applications and cosmetic packaging and cosmetic stands or displays, and packaging.

30. (canceled)
